(19) United States
(12) Patent Application Publication
(10) Pub. No.: US 2011/0316812 A1
(43) Pub. Date: Dec. 29, 2011

(54) IMAGE SENSOR CONTROL OVER A VARIABLE FUNCTION OR OPERATION

(75) Inventor: Mukesh Rao Engla Syam, Singapore (SG)

(73) Assignee: STMICROELECTRONICS ASIA PACIFIC PTE. LTD., Singapore (SG)

(21) Appl. No.: 12/822,639

(22) Filed: Jun. 24, 2010

(51) Int. Cl. G06F 3/041

(52) U.S. Cl. 345/175; 348/E05.031

(57) ABSTRACT

A device has a variable function or operation. An image sensor system is provided for the device. The image sensor system is responsive to light rays indicative of whether an object is present on an imaging window. For example, the image sensor system may be of the frustrated total internal reflection type, the light rays detected by the image sensor system comprising reflected light from the window at locations where the object is not present. The image sensor system outputs image information indicative of the detection of the light rays. A processing circuit processes the image information to detect the presence of the object on the imaging window. A control signal is generated by the processing circuit in response to that detected presence, the control signal causing the variable function or operation of the device to vary in response to the detected presence and/or movement of the object.

### TECHNICAL FIELD

The present invention relates to image sensors and the use of such image sensors to detect object placement and/or movement and in response thereto exercise control over a variable function or operation in an electronic device.

### BACKGROUND

Electronic devices have a number of variable functions or operations that are actuated by the device user. Examples of such variable functions or operations include controlling certain variably controlled features of the electronic device such as audio volume level or display brightness level. Conventionally, the electronic device is provided with an electro-mechanical button, roller-ball or sliding actuator (or the like) as the user interface with respect such variable functions or operations. It is recognized, however, that electro-mechanical buttons, roller-balls or sliding actuators on electronic devices are subject to a number of failure modes. Over time, the resiliency of the button may fail, or the mechanics of the button, roller-ball or slider may become clogged with debris, or the physical implementation of the control may break or otherwise wear out from use. It is further recognized that openings must be provided in the case or enclosure of the electronic device to support the use of electro-mechanical buttons, roller-balls or sliding actuators. Such openings in the device case or enclosure are undesirable because they provide a possible path for the entry of moisture and/or debris to the electro-mechanical buttons, roller-balls or sliding actuators and perhaps also to the internal electronics of the device.

There is a need in the art for an improved control over variable functions or operations which obviates the need for, and problems associated with, an electro-mechanical button, roller-ball or sliding actuator (or the like).

### SUMMARY

The present invention proposes the use of an image sensor to replace an electro-mechanical control device as the user interface with respect to controlling a variably controlled function or operation of a device (such as audio volume control or display brightness control).

In an embodiment, an apparatus comprises: an image sensor system of the frustrated total internal reflection type; and a processing circuit coupled to an output of the image sensor system. The processing circuit is adapted to process image information output from the image sensor system to detect an object positioned on the image sensor system and generate a control signal for varying a function or operation.

In an embodiment, a device has a variable function or operation and comprises: an image sensor system responsive to light rays indicative of whether an object is present on an imaging window, the image sensor system outputting image information in response to whether light rays are detected; and a processing circuit adapted to process the image information to detect the presence of the object on the imaging window and generate a control signal responsive to that detected presence which varies the variable function or operation of the device.

In another embodiment, a method comprises: making a frustrated total internal reflection sensing of a presence of an object on an imaging window; and generating a control signal responsive to that sensed presence which causes a variation in the variable function or operation of a device.

### BRIEF DESCRIPTION OF THE DRAWINGS

FIG. 1 illustrates an electronic device with a conventional electro-mechanical control over a variably controlled function or operation;

FIG. 2 is a side view of the electronic device of FIG. 1;

FIG. 3 illustrates an electronic device with an image sensor variable control over a variably controlled function or operation;

FIG. 4 is a side view of the electronic device of FIG. 3;

FIG. 5A illustrates a one-dimensional array configuration for the image sensor variable control;

FIG. 5B illustrates a two-dimensional array configuration for the image sensor variable control;

FIGS. 6 to 8 illustrate the frustrated total internal reflection principle used by the image sensor variable control;

FIG. 9 illustrates the process for taking a rolling window average for an array of pixel values;

FIG. 10 is a circuit diagram of an image sensor;

FIG. 11 is a timing diagram for the operation of the circuit of FIG. 10; and

FIG. 12 is a circuit diagram of an alternative implementation of the image sensor.

### DETAILED DESCRIPTION OF THE DRAWINGS

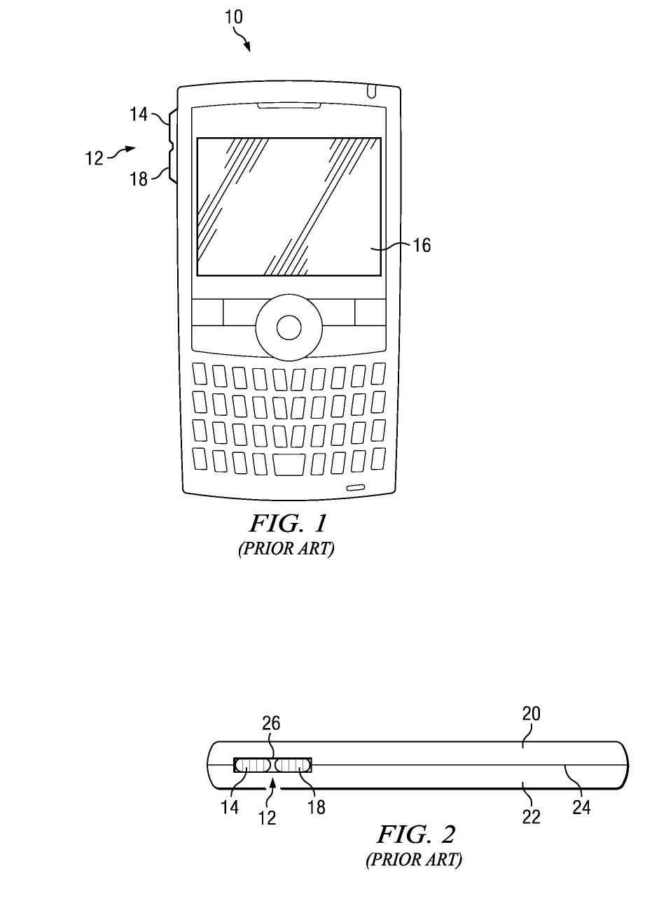

Reference is now made to FIG. 1 which illustrates an electronic device 10 with a conventional electro-mechanical control 12 over a variably controlled function or operation. In this case, the electronic device is a mobile telephone and the conventional electro-mechanical control 12 is a rocker-type push button. User actuation (for example, pushing) of one end 14 of the rocking electro-mechanical control 12 will cause an increase of a variably controlled function or operation of the electronic device such as audio volume level or brightness level of the display screen 16, while user actuation of the other end 18 of the rocking electro-mechanical control 12 will cause a decrease of the variably controlled function or operation.

FIG. 2 is a side view of the electronic device 10 of FIG. 1. The enclosure of the electronic device 10 is, for example, of the clam shell type with a top portion 20 and bottom portion 22. The top portion 20 and bottom portion 22 join together at a split line 24. An opening 26 must be provided in the enclosure to support user access to the electro-mechanical control 12. It is difficult to maintain a seal associated with this opening 26, and moisture and debris are known to enter through the opening with adverse affects on the electro-mechanical control 12 and perhaps the circuitry of the device as well. Configuration and assembly of clam shell type enclosures is well known in the art. It will further be understood that electronic devices 10 can be configured with other types of enclosures or cases, and that no matter what type is used an opening 26 will be provided to support the electro-mechanical control 12.

The present invention proposes replacing the electro-mechanical control 12 with an image sensor based control. A number of advantages accrue from this replacement. First, the image sensor based control does not include an electro-mechanical functionality which is subject to damage, deterioration, wear or mechanical failure. Second, the image sensor based control does not require the presence of an un-sealed opening in the enclosure or case of the device. Third, the image sensor based control can be mounted flush with an exterior surface of the enclosure or case, thus providing a more attractive and reliable product.

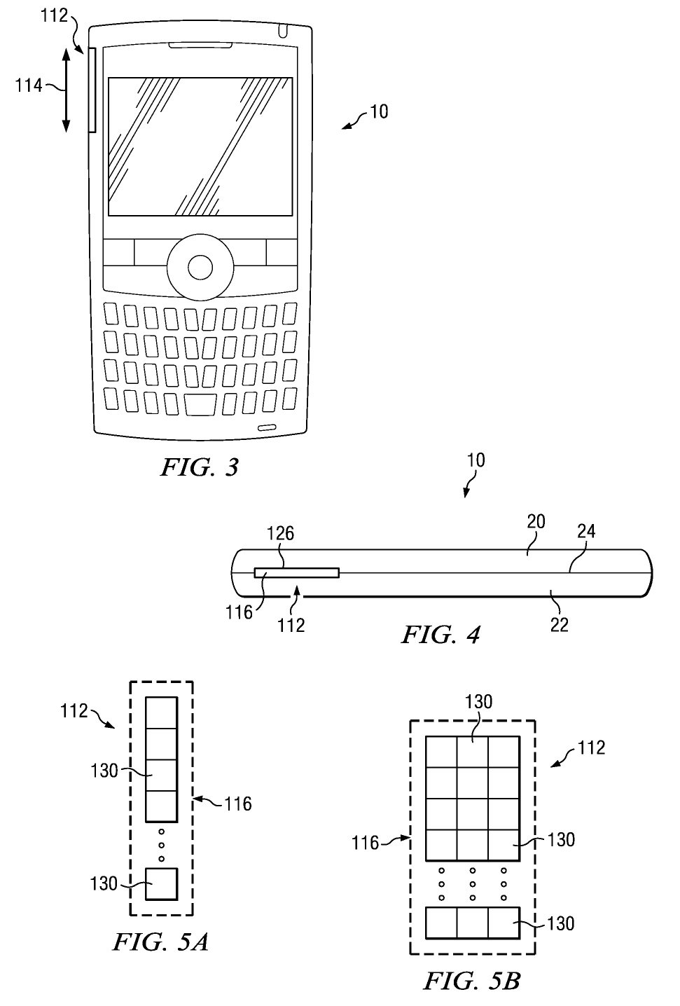

With reference now to FIG. 3, the electro-mechanical control 12 of FIG. 1 has been replaced with an image sensor variable control 112. Advantageously for the convenience of the user, the image sensor variable control 112 can be positioned at the same location as electro-mechanical control 12. The image sensor variable control 112 is mounted flush with the external surface of the device enclosure (in this case, flush with a side edge). Operation of the image sensor variable control 112, like with the electro-mechanical control 12, is made through the user's finger or thumb. However, rather than actuating one or the other ends 14 and 18 of the electro-mechanical control 12 with a push so as to modify the variable function or operation, the user instead simply places their finger or thumb along the length of the image sensor variable control 112 (for example, at either end) to cause a modification in the variable function or operation. Alternatively, the user may instead simply slide their finger or thumb along the length of the image sensor variable control 112 (as shown with arrow 114) to cause a modification in the variable function or operation. The image sensor variable control 112 detects the presence (and possibly movement) of the finger or thumb, and this detection is processed by the device to exercise variable control over a certain function or operation.

FIG. 4 is a side view of the electronic device 10 of FIG. 3. Again, the enclosure of the electronic device 10 is of the clam shell type with a top portion 20 and bottom portion 22. The top portion 20 and bottom portion 22 join together at a split line 24. The image sensor variable control 112 includes a window 116. An opening 126 is provided in the enclosure to support the inclusion of the window 116. However, unlike the opening 26 for the electro-mechanical control 12 of FIG. 2 which is not sealed, the window 116 for the image sensor variable control 112 can be sealed to the opening 126 so as to resist penetration of moisture and debris within the enclosure.

Reference is now made to FIG. 5A which illustrates a one-dimensional array configuration for the pixel sensor array of the image sensor variable control 112. The array is formed from a plurality of sensor pixels 130. The one-dimensional array configuration includes one column and m rows (wherein m=10 to 20, for example). The array of pixels 130 is positioned underneath the window 116 (schematically shown with a dotted line). Each pixel 130 includes a photodetector circuit of known configuration which operates to detect light. Each pixel 130 further includes optics, such as lenses and filters, as needed to assist in capturing light for processing by the photodetector circuit. It will be recognized by those skilled in the art that the plurality of sensor pixels 130 need not be the same size as the optics which are used. For example, the optics can implement a magnification so as to focus light on a smaller photosensor area. Thus, this enables the use of a smaller semiconductor substrate (die) size for the system of imaging pixels plus associated processing circuitry, and permits a reduction in cost.

Reference is now made to FIG. 5B which illustrates a two-dimensional array configuration for the pixel sensor array of the image sensor variable control 112. The array is formed from a plurality of sensor pixels 130. The two-dimensional array configuration includes n columns (wherein n=1 to 3, for example) and m rows (wherein m=10 to 20, for example). The array of pixels 130 is positioned underneath the window 116 (schematically shown with a dotted line). Each pixel 130 includes a photodetector circuit of known configuration which operates to detect light. Each pixel 130 further includes optics, such as lenses and filters, as needed to assist in capturing light for processing by the photodetector circuit. It will be recognized by those skilled in the art that the plurality of sensor pixels 130 need not be the same size as the optics which are used. For example, the optics can implement a magnification so as to focus light on a smaller photosensor area. Thus, this enables the use of a smaller semiconductor substrate (die) size for the system of imaging pixels plus associated processing circuitry, and permits a reduction in cost.

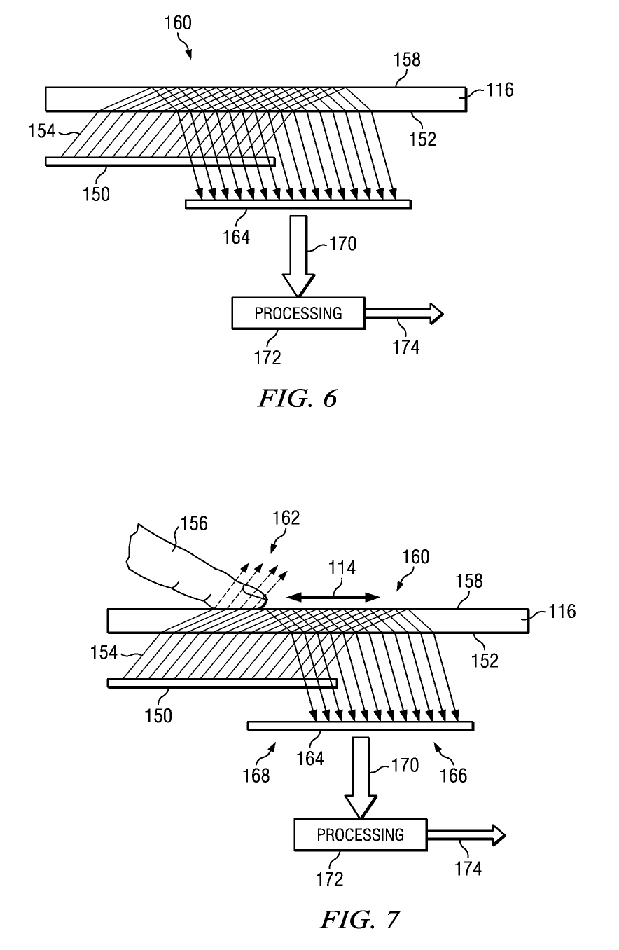

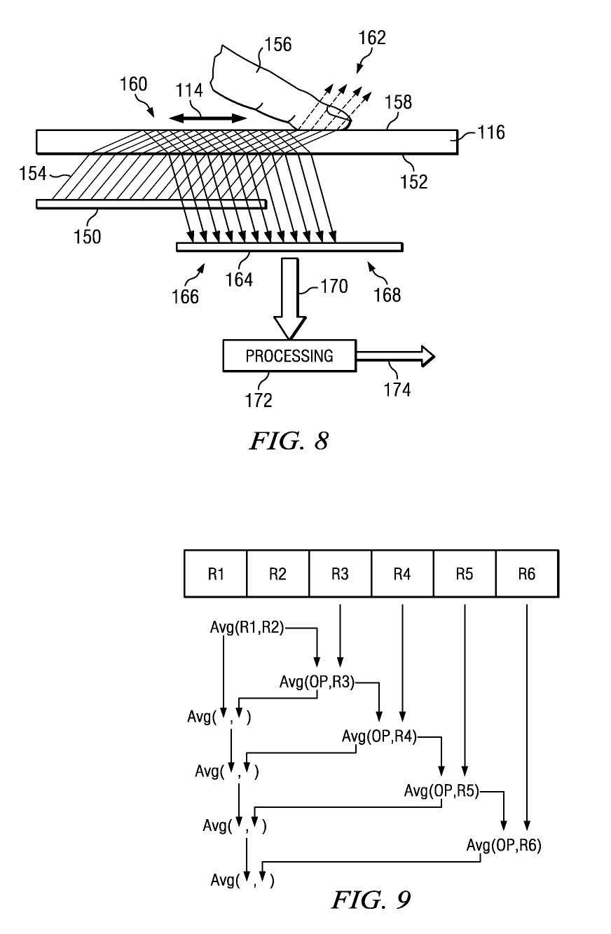

The image sensor variable control 112 preferably utilizes an image sensor system that operates on the frustrated total internal reflection principle as illustrated in FIG. 6 (although it will be understood that other types of imaging circuits sensitive to light detection could alternatively be used). Light originates from a plurality of points in a source array 150 (it will be recognized that source array 150 need not provide a plurality of individual light sources, but rather that the source array 150 supply light in a manner which relatively uniformly illuminates an underside surface 152 of the window 116. Thus, the light from the source 150 is directed towards the underside surface 152 of the window 116, where the individual light rays 154 are refracted towards an upperside surface 158 of the window 116. If there is no object present on the upperside surface 158 of the window 116, the light rays 154 are totally reflected (reference 160) by the upperside surface 158. The reflected rays 154 (from reference 160) are refracted again by the underside surface 152 and directed towards a detector array 164. The detector array 164 (including the plurality of pixels 130 as in FIG. 5A or 5B) is provided to detect the reflected rays 154. Where an object is present on the upperside surface 158 of the window 116, the total internal reflection (reference 160) as described above is frustrated. This is illustrated in more detail with respect to FIGS. 7 and 8 which further show how this frustration effect can be used to detect the presence (and also movement) of the object on the window 116 for the purpose of exercising control over a variable function or operation of the device.

Reference is now made to FIGS. 7 and 8. If there is an object (such as a user's finger or thumb) 156 present on the upperside surface 158 of the window, the individual light rays 154 which hit the upperside surface 158 of the window at the location of the object 156 are not reflected (reference 162) by the upperside surface 158 (i.e., total internal reflection is frustrated). Thus, only the reflected rays 154 (from reference 160) are refracted again by the underside surface 152. The detector array 164 (including the plurality of pixels 130 as in FIG. 5A or 5B) detects the reflected ones of the rays 154, and from this detection of rays information concerning the presence and location of the object 156 on the upperside surface 158 of the window 116 may be obtained. In this regard, it will be noted that individual detectors (not explicitly shown but see pixels 130 in FIGS. 5A and 5B) in region 166 of the detector array 164 will detect rays 154, while individual detectors (pixels 130) in region 168 of the detector array 164 will not.

Signals 170 output from the detector array 164 are processed by a processing circuit 172 to identify the presence and location of the object 156. The processing circuit may, for example, be a portion of a larger processing circuit for the device. In a preferred implementation, the processing circuit is placed on the same integrated circuit substrate as the detector array 164. Control actions 174 over a variable function or operation of an electronic device may then be made in response to the identified presence and location.

The detector array 164 may take the form of a plurality of sensor pixels 130 arranged in the manner shown in FIG. 5A or FIG. 5B, with one ray 154 being associated with one pixel 130.

In one implementation, as discussed above, the user will place their finger or thumb at a position along the length of the image sensor variable control 112 (for example, at either end) to cause a modification in the variable function or operation. When the object (such as a user's finger or thumb) 156 is present on one end of the image sensor control 112 window 116 (as shown in FIG. 7), the detector array 164 will detect only the reflected ones of the rays 154 (from reference 160), and there will be no detected reflected rays from the frustrated area of reference 162 where the object is located. The processing circuit 172 will process the detector array 164 output information relating to detected ray information so as to identify the presence of the object (such as a user's finger or thumb) 156 on the window 116, as well as identify the object's location at the left end of the window. Responsive thereto, the processing circuit 172 will issue a control action 174 over a variable function or operation of the electronic device such as increasing the variable (for example, audio volume or display brightness).

Conversely, if the object (such as a user's finger or thumb) 156 is instead present at the other end of the window 116 (as shown in FIG. 8), the detector array 164 will detect only the reflected ones of the rays 154 (from reference 160), and there will be no detected reflected rays from the frustrated area of reference 162 where the object is located. The processing circuit 172 will process the detector array 164 output information relating to the detected ray information so as to identify the presence of the object (such as a user's finger or thumb) 156 on the window 116, as well as the object's location at the right end of the window. Responsive thereto, the processing circuit 172 will issue a control action 174 over a variable function or operation of the electronic device such as decreasing the variable (for example, audio volume or display brightness).

In an alternative implementation, as discussed above, the user may instead simply slide their finger or thumb along the length of the image sensor variable control 112 (as shown with arrow 114) to cause a modification in the variable function or operation. When the object (such as a user's finger or thumb) 156 is present at one position of the image sensor variable control 112 window 116 (as shown in FIG. 7), the detector array 164 will detect the reflected ones of the rays 154 (from reference 160), and there will be no detected reflected rays from the reference 162 where the object is located and reflection is frustrated. As the user slides 114 the object 156 along the length of the window 116 toward the position shown in FIG. 8 the references 160 and 162 will change in location along the window. More specifically, the detector array 164 will detect different reflected ones of the rays 154 in response to object movement. The processing circuit 172 will process the detector array 164 output information relating to the detected ray information over time (for example, using frame-by-frame analysis) to identify the presence of the object (such as a user's finger or thumb) 156 on the window 116, as well as its movement and direction of movement (for example, from the left end of the window (FIG. 7) towards the right end of the window (FIG. 8)). Responsive thereto, the processing circuit 172 will issue a control action 174 over a variable function or operation of the electronic device such as decreasing the variable (for example, audio volume or display brightness).

Conversely, if the object (such as a user's finger or thumb) 156 is instead moving 114 in the other direction (for example, from the right end of the window (FIG. 8) towards the left end of the window (FIG. 7)), the locations or positions of references 160 and 162 will change. More specifically, the detector array 164 will detect different reflected ones of the rays 154 in response to object movement. The processing circuit 172 will process the detector array 164 output information relating to the detected ray information over time (for example, on a frame-by-frame basis) to identify the presence of the object (such as a user's finger or thumb) 156 on the window 116, as well as its movement and direction of movement. Responsive thereto, the processing circuit 172 will issue a control action 174 over a variable function or operation of the electronic device such as increasing the variable (for example, audio volume or display brightness).

In the case of the moving object implementation, the processing circuit 172 may utilize a rolling window algorithm for the purpose of detecting movement and direction of movement by processing pixel information collected over time. An exemplary rolling window algorithm process is as follows:
for a given frame of pixel data:
   (a) calculate average pixel value for each row (if there is more than one pixel per row (such as with FIG. 5B));
   (b) store calculated averages in a first line memory (L1);
   (c) calculate from the stored L1 data a rolling window average with respect to all rows of that frame (as shown in FIG. 9, where “OP” is the output of the previous averaging and there are an exemplary six rows R1-R6 of data); and
   (d) store calculated average in a second line memory (L2);
repeat the previous operations (a)-(d) to collect N frames of data (N>=2); and
process the stored L2 data for N frames of operation in accordance with the following algorithm in order to determine movement of the object (Going Down, Going Up, Not Moving):

```
for(i=0; i<N; i++)
{
  if(L2[i]<L2[i+1])
    flag=1 ;
  else is(L2[i]>L2[i+1])
    flag=0;
  else
    flag=2;
}
if(flag == 0)
  Going Down
else if(flag == 1)
  Going Up
else if(flag == 2)
  Not Moving
end
```

The process of (a)-(d) calculates the rolling window average L2 for detected pixel information of a given frame based on row average data L1, the value L2 being indicative of the relative location of the object (if present), at the time of that given frame, along the length of the window. This process of (a)-(d) is performed N times (N>=2), with each operation calculating the rolling window average L2 for an individual frame in a sequence of frames, the value L2 again being indicative of the relative location of the object (if present) along the length of the window. Movement can be determined by comparing rolling window averages L2 for at least two consecutive frames. Because the rolling window averages L2 have values indicative of relative object location, the comparison of the two values provides information on whether the object has moved from one frame to the next. So, if L2 for a first frame is different than L2 for a second frame, then the object has moved. The absolute value of the difference between the two L2 values provides information indicative of the magnitude of the movement, while the sign of the difference between the two L2 values provides information indicative of the direction of movement. This magnitude and direction information is transformed by the processor into the control action 174 over the variable function or operation of the electronic device such as increasing/decreasing the variable (for example, audio volume or display brightness).

The algorithm provided above which compares the two L2 values to each other (using greater than, less than or equal to comparisons) provides a very simple method for determining direction of object movement using the L2 measurements. This determined direction information is then used to issue the control action 174 over a variable function or operation of the electronic device such as increasing/decreasing the variable (for example, audio volume or display brightness). A magnitude of movement, or perhaps also a duration of movement, can be determined from the number of consecutive evaluated frames with similar values (i.e., the number of consecutive times through the “for loop” for which the L2 comparison indicates movement in a same direction (based on the “flag” value)). The processor can then transform that magnitude/duration information into a more refined control action 174 over the variable function or operation which provides not only direction of variable control but also magnitude and/or rate of change of the variable control.

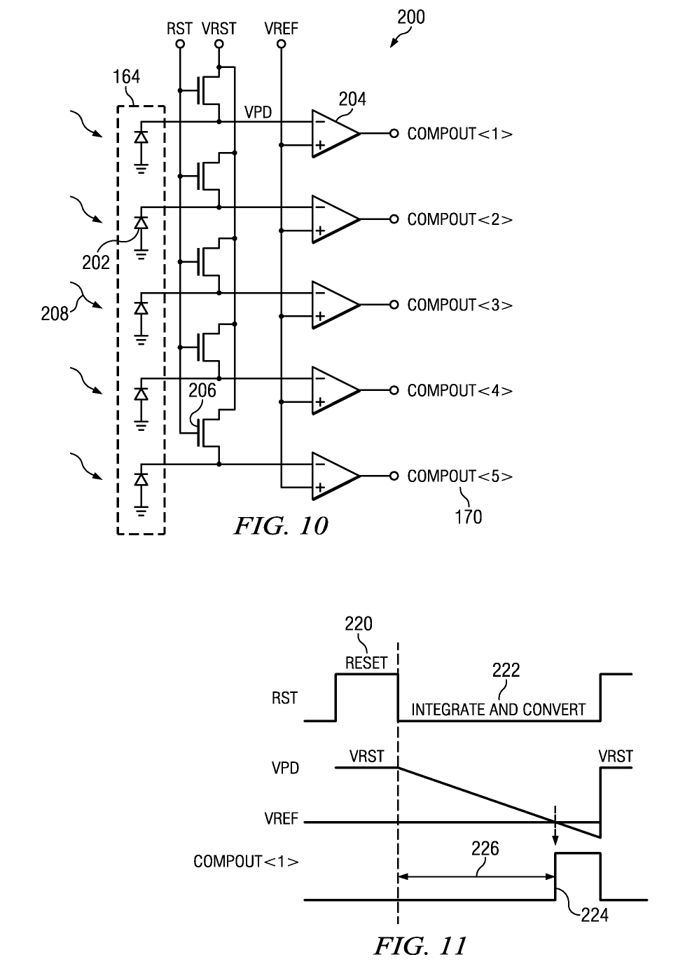

Reference is now made to FIG. 10 which shows a circuit diagram of an image sensor 200 for use within the image sensor system of the image sensor variable control 112. The image sensor 200 includes the detector array 164 (including the plurality of pixels 130 as in FIG. 5A or 5B). The detector array 164 includes a plurality of photosensors 202 (illustrated here as photodiodes). The anode of the photosensors 202 is coupled to ground. The cathode of each photosensor is coupled the negative input of a comparator 204. The output of the comparator 204 is a COMPOUT signal, there being one COMPOUT signal for each photosensor 202. The positive input of each comparator 204 is coupled to a reference voltage VREF. The cathode of each photosensor 202 is further coupled to the drain of a reset transistor 206. The source of each transistor 206 is coupled to a reset voltage VRST. The gate of each transistor 206 is coupled to a reset signal line RST.

Reference is now additionally made to FIG. 11. When RST is high, the transistors 206 are turned on and the reset voltage VRST charges each photosensor 202 (with the reset voltage being stored on the capacitance associated with each photosensor) as shown at reference 220. When RST subsequently goes low, the stored reset voltage VRST is dissipated through the photodiode to ground as a function of the light 208 which impinges on the photodiode as shown at reference 222. The voltage across the photodiode (VPD) is compared by the comparator 204 to the reference voltage VREF. When the voltage becomes less than the reference voltage VREF, the COMPOUT signal will change state as shown at reference 224. The collected COMPOUT signals for the detector array 164 comprise the signals 170 output from the detector array 164 which are processed by a processing circuit 172 to identify the presence, location and movement of the object 156.

In one implementation, it is noted that the time 226 it takes for the COMPOUT signal to change state is proportional to the amount of light 208 which impinges on the photodiode. This time value is then converted by the processing circuit 172 to light value and the light values are processed by the processing circuit 172 to identify the presence of the object and determine whether the object is moving (and if so, in what direction is the object moving).

With reference once again to FIG. 6, since the entire detector array 164 is receiving reflected light, the circuitry will detect a high light value for all pixels in this situation from the output COMPOUT signals. With reference to FIGS. 7 and 8, the photodiodes in the region 166 of the detector array 164 receive reflected light and the circuitry will detect high light values for those pixels in region 166. Conversely, the photodiodes in the region 168 of the detector array 164 do not receive reflected light and the circuitry will detect low light values for those pixels in region 164. The light values accordingly provide information concerning presence of the object as well as its location, and if those values are monitored over time then information concerning movement of the object and direction of movement can be discerned.

In another implementation, it is noted that the COMPOUT signal for those photodiodes which are not exposed to light will not change state because the voltage across the diode does not dissipate within the integration and conversion time period. The states are then processed by the processing circuit 172 to identify the presence of the object and determine whether the object is moving (and if so, in what direction is the object moving).

With reference once again to FIG. 6, since the entire detector array 164 is receiving reflected light, all COMPOUT signals will change state in this situation within the integration and conversion period. With reference to FIGS. 7 and 8, the photodiodes in the region 166 of the detector array 164 receive reflected light and the COMPOUT signals for the pixels in region 166 will change state. Conversely, the photodiodes in the region 168 of the detector array 164 do not receive reflected light and the COMPOUT signals for the pixels in the region 168 will not change state. The state values accordingly provide information concerning presence of the object as well as its location, and if those state values are monitored over time then information concerning movement of the object and direction of movement can be discerned

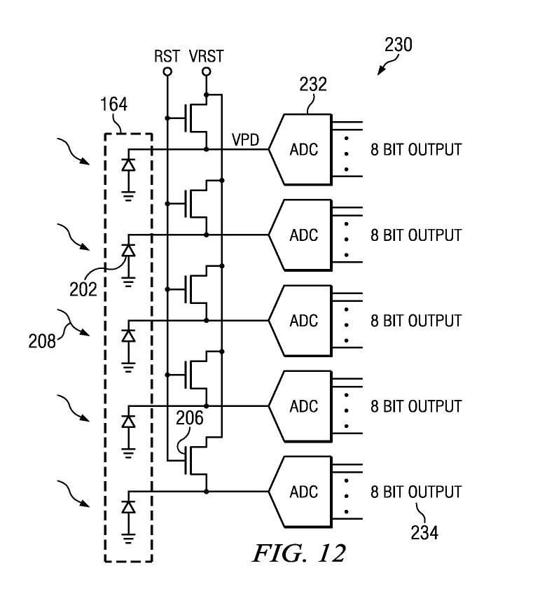

Reference is now made to FIG. 12 which shows a circuit diagram of an alternative implementation of the image sensor 230 for use within the image sensor system of the image sensor variable control 112. The image sensor 230 includes the detector array 164 (including the plurality of pixels 130 as in FIG. 5A or 5B). The detector array 164 includes a plurality of photosensors 202 (illustrated here as photodiodes). The anode of the photosensors 202 is coupled to ground. The cathode of each photosensor is coupled the input of an analog-to-digital converter (ADC) 232. The output of the converter 232 is a multi-bit digital signal 234, there being one multi-bit signal 234 for each photosensor 202. The cathode of each photosensor 202 is further coupled to the drain of a reset transistor 206. The source of each transistor 206 is coupled to a reset voltage VRST. The gate of each transistor 206 is coupled to a reset signal line RST.

When RST is high, the transistors 206 are turned on and the reset voltage VRST charges each photosensor 202 (with the reset voltage being stored on the capacitance associated with each photosensor). When RST subsequently goes low, the stored reset voltage VRST is dissipated through the photodiode to ground as a function of the light 208 which impinges on the photodiode. The voltage across the photodiode (VPD) is converted by the ADC 232 to a digital value represented by the multi-bit signal 234. For the photodiodes in the region 166 of the detector array 164 which receive light, the digital value of the multi-bit signal 234 will change substantially over an integration and conversion time and be relatively low at the end of the integration and conversion time period. Conversely, for the photodiodes in the region 168 of the detector array 164 which do not receive reflected light, the digital value of the multi-bit signal 234 will not change substantially over the integration and conversion time and be relatively high at the end of the integration and conversion time period. The collected multi-bit signals 234 for the detector array 164 comprise the signals 170 output from the detector array 164 which are processed by a processing circuit 172 to identify the presence and location of the object 156.

With reference once again to FIG. 6, since the entire detector array 164 is receiving reflected light, the digital value of the multi-bit signal 234 will change substantially over the integration and conversion time period for all pixels. With reference to FIGS. 7 and 8, the photodiodes in the region 166 of the detector array 164 receive reflected light and the digital value of the multi-bit signal 234 will change substantially over the time period for those pixels in region 166. Conversely, the photodiodes in the region 168 of the detector array 164 do not receive reflected light and the digital value of the multi-bit signal 234 will not change substantially over the time period for those pixels in region 164. The digital values of the multi-bit signals 234 accordingly provide information concerning presence of the object as well as its location, and if those values are monitored over time then information concerning movement of the object and direction of movement can be discerned.

Although preferred embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. Apparatus, comprising:
an image sensor system of the frustrated total internal reflection type; and
a processing circuit coupled to an output of the image sensor system, the processing circuit adapted to process image information output from the image sensor system to detect an object positioned on the image sensor system and generate a control signal for varying a function or operation.

2. The apparatus of claim 1 wherein the image sensor system has a window with a length, and wherein the image information output from the image sensor system is processed to determine a relative position of the detected object along the length, the control signal for varying the function or operation being indicative of the determined relative position.

3. The apparatus of claim 1 wherein the image sensor system has a window with a length, and wherein the image information output from the image sensor system is processed to determine a relative movement of the detected object along the length, the control signal for varying the function or operation being indicative of the determined relative movement.

4. The apparatus of claim 1 wherein the image sensor system of the frustrated total internal reflection type comprises:
a light source;
a window having an underside surface and an upperside surface, light from the light source being directed towards the underside surface and reflected, in the absence of the object, by the underside surface, the light from the light source being refracted in the presence of the object; and
a photodetector array including a plurality of pixels positioned to receive the reflected light from the underside surface.

5. The apparatus of claim 4 wherein the processing circuit responds to photodetector array detection of the reflected light from the underside surface to determine the presence of the object.

6. The apparatus of claim 5 wherein the processing circuit further generates the control signal for varying a function or operation in response to the determined presence of the object.

7. The apparatus of claim 4 wherein the processing circuit responds to photodetector array detection of the reflected light from the underside surface to determine the presence of the object and a relative location of the object on the window.

8. The apparatus of claim 7 wherein the processing circuit further generates the control signal for varying a function or operation in response to the determined presence and relative location of the object.

9. A device having a variable function or operation, comprising:
an image sensor system responsive to light rays indicative of whether an object is present on an imaging window, the image sensor system outputting image information in response to whether light rays are detected; and
a processing circuit adapted to process the image information to detect the presence of the object on the imaging window and generate a control signal responsive to that detected presence which varies the variable function or operation of the device.

10. The device of claim 9 wherein the variable function or operation of the device is an audio volume.

11. The device of claim 9 wherein the variable function or operation of the device is a display brightness.

12. The device of claim 9 wherein the imaging window has a length, and the image information output from the image sensor system is processed by the processing circuit to determine a relative position of the object along the length, the generated control signal varying the variable function or operation as a function of the determined relative location.

13. The device of claim 9 wherein the imaging window has a length, and the image information output from the image sensor system is processed by the processing circuit to determine a relative movement of the object along the length, the generated control signal varying the variable function or operation as a function of the determined relative movement.

14. The device of claim 9 wherein the image sensor system is a frustrated total internal reflection type sensor, comprising:
a light source directing light toward an underside surface of the window, that light being reflected by the underside surface in the absence of the object and being refracted by the underside surface in the presence of the object; and
a photodetector array including a plurality of pixels positioned to receive the reflected light from the underside surface.

15. The device of claim 14 wherein the processing circuit responds to photodetector array detection of the reflected light from the underside surface to determine the presence of the object.

16. The device of claim 15 wherein the control signal generated by the processing circuit further varies the variable function or operation in response to the determined presence of the object.

17. The device of claim 14 wherein the processing circuit responds to photodetector array detection of the reflected light from the underside surface to determine the presence of the object and a relative location of the object on the window.

18. The device of claim 17 wherein the control signal generated by the processing circuit further varies the variable function or operation in response to the determined presence and relative location of the object.

19. A method, comprising:
making a frustrated total internal reflection sensing of a presence of an object on an imaging window; and
generating a control signal responsive to that sensed presence which causes a variation in the variable function or operation of a device.

20. The method of claim 19 wherein the variable function or operation of the device is an audio volume.

21. The method of claim 19 wherein the variable function or operation of the device is a display brightness.

22. The method of claim 19 further comprising determining a relative position of the object along a length of the window, the generated control signal varying the variable function or operation as a function of the determined relative location.

23. The method of claim 19 further comprising determining a relative movement of the object along a length of the window, the generated control signal varying the variable function or operation as a function of the determined relative movement.
